(19) United States
(12) Patent Application Publication
(10) Pub. No.: US 2013/0090926 A1
(43) Pub. Date: Apr. 11, 2013

(54) MOBILE DEVICE CONTEXT INFORMATION USING SPEECH DETECTION

(71) Applicants: Leonard Henry Grokop, San Diego, CA (US); Shankar Sadasivam, San Diego, CA (US)

(72) Inventors: Leonard Henry Grokop, San Diego, CA (US); Shankar Sadasivam, San Diego, CA (US)

(73) Assignee: QUALCOMM INCORPORATED, San Diego, CA (US)

(21) Appl. No.: 13/486,878

(22) Filed: Jun. 1, 2012

Related U.S. Application Data
(60) Provisional application No. 61/535,838, filed on Sep. 16, 2011.

(51) Int. Cl. G10L 19/02; G10L 15/08

(52) U.S. Cl. CPC G10L 19/02; G10L 15/08
USPC 704/243; 704/231

(57) ABSTRACT

Systems and methods for speech detection in association with a mobile device are described herein. A method described herein for identifying presence of speech associated with a mobile device includes obtaining a plurality of audio samples from the mobile device while the mobile device operates in a mode distinct from a voice call operating mode, generating spectrogram data from the plurality of audio samples, and determining whether the plurality of audio samples include information indicative of speech by classifying the spectrogram data.

### CROSS-REFERENCE TO RELATED APPLICATIONS

This application claims the benefit of and priority to U.S. Provisional Application Ser. No. 61/535,838, filed Sep. 16, 2011 and entitled “MOBILE DEVICE CONTEXT INFORMATION USING SPEECH DETECTION,” the content of which is hereby incorporated by reference in its entirety.

### BACKGROUND

Advancements in wireless communication technology have greatly increased the versatility of today's wireless communication devices. These advancements have enabled wireless communication devices to evolve from simple mobile telephones and pagers into sophisticated computing devices capable of a wide variety of functionality such as multimedia recording and playback, event scheduling, word processing, e-commerce, etc. As a result, users of today's wireless communication devices are able to perform a wide range of tasks from a single, portable device that conventionally required either multiple devices or larger, non-portable equipment.

One such advancement in mobile device technology is the ability to detect and use device and user context information, such as the location of a device, events occurring in the area of the device, etc., in performing and customizing functions of the device. One way in which a mobile device can be made aware of its user's context is the identification of dialogue in the ambient audio stream. For instance, a device can monitor the ambient audio environment in the vicinity of the device and its user and determine when conversation is taking place. This information can then be used to trigger more detailed inferences such as speaker and/or user recognition, age and/or gender estimation, estimation of the number of conversation participants, etc. Alternatively, the act of identifying conversation can itself be utilized as an aid in context determination. For instance, detected conversation can be utilized to determine whether a user located in his office is working alone or meeting with others, which may affect the interruptibility of the user.

### SUMMARY

An example of a method for identifying presence of speech associated with a mobile device according to the disclosure includes obtaining audio samples from the mobile device while the mobile device operates in a mode distinct from a voice call operating mode, generating spectrogram data from the audio samples, and determining whether the audio samples include information indicative of speech by classifying the spectrogram data.

Implementations of the method may include one or more of the following features. Obtaining noncontiguous samples of ambient audio at an area near the mobile device. Classifying the spectrogram data using at least one support vector machine (SVM). Partitioning the spectrogram data into temporal frames, obtaining individual decisions for each of the frames indicative of whether speech is detected in respective ones of the frames, and combining the individual decisions to obtain an overall decision relating to whether the audio samples include information indicative of speech. Combining the individual decisions based on a number of individual decisions for which speech is detected relative to a total number of the individual decisions. Comparing the number of individual decisions for which speech is detected to a threshold that is based on at least one of a desired detection probability or a desired false alarm probability. Partitioning the spectrogram data into non-overlapping temporal frames. Computing a statistical proximity of features of the spectrogram data for each of the frames to features of a reference speech model. Generating the reference speech model using a training procedure. Randomizing an order of the audio samples prior to generating the spectrogram data.

An example of a speech detection system according to the disclosure includes an audio sampling module, an audio spectrogram module and a classifier module. The audio sampling module is configured to obtain audio samples associated with an area at which a device is located while the device operates in a mode distinct from a voice call operating mode. The audio spectrogram module is communicatively coupled to the audio sampling module and configured to generate spectrogram data from the audio samples. The classifier module is communicatively coupled to the audio spectrogram module and configured to determine whether the audio samples include information indicative of speech by classifying the spectrogram data.

Implementations of the system may include one or more of the following features. The audio sampling module is further configured to obtain the plurality of audio samples by obtaining noncontiguous samples of ambient audio associated with the area at which the device is located. The classifier module is further configured to classify the spectrogram data using at least one SVM. The audio spectrogram module is further configured to partition the spectrogram data into temporal frames, and the classifier module is further configured to classify the spectrogram data by obtaining individual decisions for each of the frames indicative of whether speech is detected in respective ones of the frames and combining the individual decisions to obtain an overall decision relating to whether the plurality of audio samples include information indicative of speech. The classifier module is further configured to combine the individual decisions by comparing a number of individual decisions for which speech is detected to a threshold that is based on at least one of a desired detection probability or a desired false alarm probability. The audio spectrogram module is further configured to partition the spectrogram data into non-overlapping temporal frames. The classifier module is further configured to classify the spectrogram data by computing a statistical proximity of features of the spectrogram data for each of the frames to features of a reference speech model. The classifier module is further configured to generate the reference speech model using a training procedure. The audio sampling module is further configured to randomize an order of the audio samples prior to processing of the audio samples by the audio spectrogram module. A microphone communicatively coupled to the audio sampling module and configured to produce an audio signal based on ambient audio associated with the area at which the device is located, and the audio sampling module is configured to obtain the audio samples from the audio signal. The device is a mobile wireless communication device.

An example of a system for detecting presence of speech in an area associated with a mobile device according to the disclosure includes sampling means for obtaining audio samples from the area associated with the mobile device while the mobile device operates in a mode distinct from a voice call operating mode; spectrogram means, communicatively coupled to the sampling means, for generating a spectrogram comprising spectral density data corresponding to the audio samples; and classifier means, communicatively coupled to the spectrogram means, for determining whether the audio samples include information indicative of speech by classifying the spectral density data of the spectrogram.

Implementations of the system may include one or more of the following features. Means for obtaining noncontiguous samples of ambient audio from the area associated with the mobile device. Means for classifying the spectral density data of the spectrogram using at least one SVM. Means for partitioning the spectrogram into temporal frames, means for obtaining individual decisions for each of the frames of the spectrogram indicative of whether speech is detected in respective ones of the frames, and means for combining the individual decisions to obtain an overall decision relating to whether the audio samples include information indicative of speech. Means for combining the individual decisions by comparing a number of individual decisions for which speech is detected to a threshold that is based on at least one of a desired detection probability or a desired false alarm probability. Means for partitioning the spectrogram into non-overlapping temporal frames. Means for classifying the spectrogram by computing a statistical proximity of features of the spectrogram for each of the frames to features of a reference speech model. Means for generating the reference speech model using a training procedure. Means for randomizing an order of the audio samples prior to processing of the audio samples by the spectrogram means.

An example of a computer program product according to the disclosure resides on a processor-executable computer storage medium and includes processor-executable instructions configured to cause a processor to obtain audio samples from an area associated with a mobile device while the mobile device operates in a mode distinct from a voice call operating mode, generate a spectrogram comprising spectral density data corresponding to the audio samples, and determine whether the audio samples include information indicative of speech by classifying the spectral density data of the spectrogram.

Implementations of the computer program product may include one or more of the following features. Instructions configured to cause the processor to obtain noncontiguous samples of ambient audio from the area associated with the mobile device. Instructions configured to cause the processor to classify the spectral density data of the spectrogram using at least one SVM. Instructions configured to cause the processor to partition the spectrogram into temporal frames, to obtain individual decisions for each of the frames of the spectrogram indicative of whether speech is detected in respective ones of the frames, and to combine the individual decisions to obtain an overall decision relating to whether the audio samples include information indicative of speech. Instructions configured to cause the processor to combine the individual decisions by comparing a number of individual decisions for which speech is detected to a threshold that is based on at least one of a desired detection probability or a desired false alarm probability. Instructions configured to cause the processor to partition the spectrogram into non-overlapping temporal frames. Instructions configured to cause the processor to classify the spectrogram by computing a statistical proximity of features of the spectrogram for each of the frames to features of a reference speech model. Instructions configured to cause the processor to generate the reference speech model using a training procedure. Instructions configured to cause the processor to randomize an order of the audio samples prior to generation of the spectrogram.

Items and/or techniques described herein may provide one or more of the following capabilities, as well as other capabilities not mentioned. The presence of speech in an audio stream can be detected with high reliability in the presence of muffling and/or other quality degradation of the audio stream. Speech can be detected from intermittent samples of the ambient audio stream in order to improve user privacy and device battery life. Detection accuracy can be improved by observing and analyzing temporal correlations in an audio stream over long time periods (e.g., several seconds). Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a block diagram of components of a mobile computing device.

FIG. 2 is a block diagram of a speech detection system.

FIGS. 3-6 are illustrative views of spectrograms generated from audio signal data.

FIG. 7 is an illustrative view of audio sampling and windowing operations performed by the speech detection system shown in FIG. 2.

FIG. 8 is a functional block diagram of a system for classifying audio samples and performing speech detection.

FIG. 9 is a block flow diagram of a process of identifying presence of speech associated with a device.

FIG. 10 is a block flow diagram of a process of processing and classifying samples obtained from an audio signal.

FIG. 11 illustrates a block diagram of an embodiment of a computer system.

### DETAILED DESCRIPTION

Described herein are techniques for detecting the presence of speech in the vicinity of a device, such as a smartphone or other mobile communication device and/or any other suitable device. The techniques described herein can be utilized to aid in device context determination, as well as for other uses.

Techniques such as voice activity detection (VAD) can be utilized to determine whether a given audio frame contains speech, e.g., in order to decide if the audio frame should be transmitted over an associated cellular network during a voice call. However, these techniques are undesirable for a generalized device use case for various reasons. For example, if a user is not actively engaged in a voice call on a device, the user may not provide active assistance in removing obstructions from the device and influencing the direction of speech toward an associated microphone as the user would otherwise. As a result, an audio signal associated with the device can be muffled in an arbitrary way, due to the device being located in an arbitrary position with respect to the user (e.g., in a pant/shirt/jacket pocket, hand, bag, purse, holster, etc.). Similarly, the signal-to-noise ratio (SNR) of the ambient audio stream at the device will be reduced (e.g., to below 0 dB) if the microphone of the device is not near the speaker's mouth, the device is concealed (e.g., in a pocket or bag), the background noise level near the device is high, etc.

The techniques described herein can additionally operate using sets of ambient audio samples that are collected over time. For instance, it may be desirable in some cases to utilize a sparse and intermittent subsampling of the ambient audio stream due to user privacy or battery life concerns associated with continuous recording of ambient audio and/or for other reasons. Additionally, the techniques described herein can be configured with an operational latency that is on a significantly greater time scale than that of conventional techniques, e.g., on the order of several seconds. Thus, the techniques described herein can exploit correlations in the audio stream across these longer periods of time. As described in further detail herein, at least some of the techniques described herein can also be utilized to distinguish speech from audio which has similar energy and spectral properties, such as music. At least some of the techniques described herein additionally enable speech detection and device context inference in operating modes distinct from a voice call operating mode.

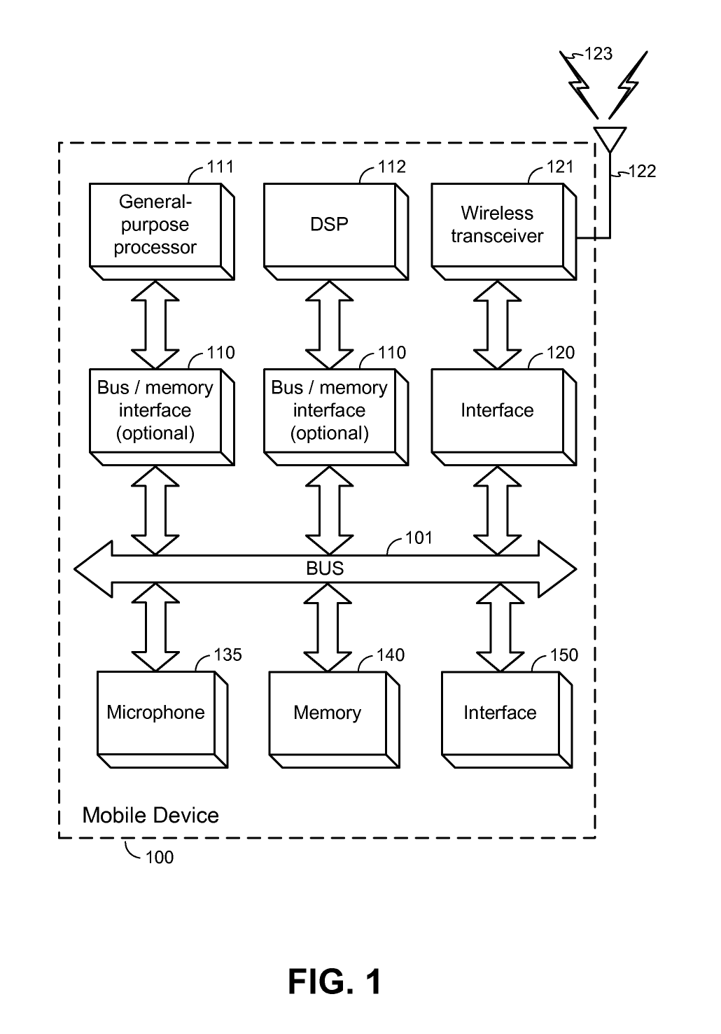

Referring to FIG. 1, an example mobile device 100 includes a wireless transceiver 121 that sends and receives wireless signals 123 via a wireless antenna 122 over a wireless network. The transceiver 121 is connected to a bus 101 by a wireless transceiver bus interface 120. While shown as distinct components in FIG. 1, the wireless transceiver bus interface 120 may also be a part of the wireless transceiver 121. Here, the mobile device 100 is illustrated as having a single wireless transceiver 121. However, a mobile device 100 can alternatively have multiple wireless transceivers 121 and wireless antennas 122 to support multiple communication standards such as WiFi, Code Division Multiple Access (CDMA), Wideband CDMA (WCDMA), Long Term Evolution (LTE), Bluetooth, etc.

A general-purpose processor 111, memory 140, digital signal processor (DSP) 112 and/or specialized processor(s) (not shown) may also be utilized to process the wireless signals 123 in whole or in part. Storage of information from the wireless signals 123 is performed using a memory 140 or registers (not shown). While only one general purpose processor 111, DSP 112 and memory 140 are shown in FIG. 1, more than one of any of these components could be used by the mobile device 100. The general purpose processor 111 and DSP 112 are connected to the bus 101, either directly or by a bus interface 110. Additionally, the memory 140 is connected to the bus 101 either directly or by a bus interface (not shown). The bus interfaces 110, when implemented, can be integrated with or independent of the general-purpose processor 111, DSP 112 and/or memory 140 with which they are associated.

The memory 140 includes a non-transitory computer-readable storage medium (or media) that stores functions as one or more instructions or code. Media that can make up the memory 140 include, but are not limited to, RAM, ROM, FLASH, disc drives, etc. Functions stored by the memory 140 are executed by the general-purpose processor 111, specialized processor(s), or DSP 112. Thus, the memory 140 is a processor-readable memory and/or a computer-readable memory that stores software code (programming code, instructions, etc.) configured to cause the processor 111 and/or DSP 112 to perform the functions described. Alternatively, one or more functions of the mobile device 100 may be performed in whole or in part in hardware.

The mobile device 100 further includes a microphone 135 that captures ambient audio in the vicinity of the mobile device 100. While the mobile device 100 here includes one microphone 135, multiple microphones 135 could be used, such as a microphone array, a dual-channel stereo microphone, etc. Multiple microphones 135, if implemented by the mobile device 100, can operate interdependently or independently of one another. The microphone 135 is connected to the bus 101, either independently or through a bus interface 110. For instance, the microphone 135 can communicate with the DSP 112 through the bus 101 in order to process audio captured by the microphone 135. The microphone 135 can additionally communicate with the general-purpose processor 111 and/or memory 140 to generate or otherwise obtain metadata associated with captured audio.

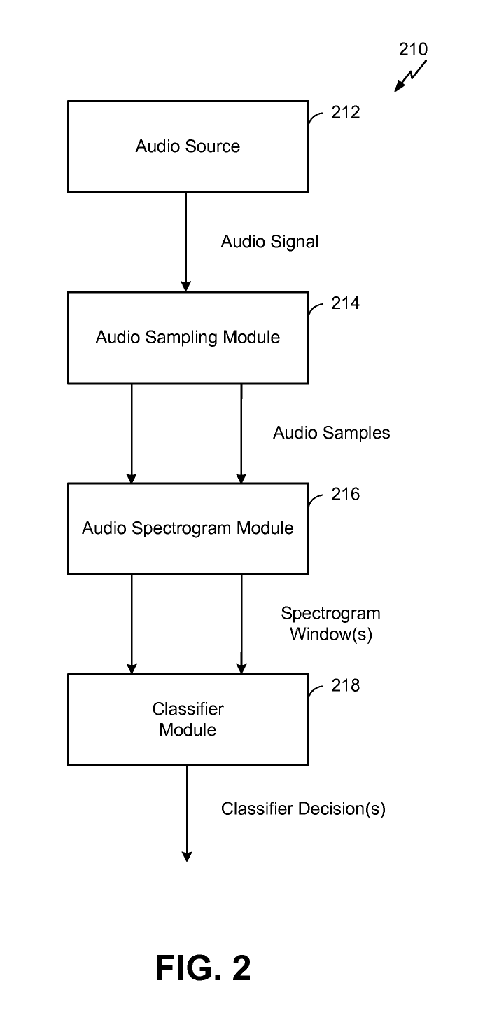

FIG. 2 illustrates an embodiment of a speech detection system 210 that identifies the presence of speech within the vicinity of an associated device. The system 210 includes an audio source 212, implemented here by the microphone 135, which converts ambient audio within the area of the audio source 212 into an audio signal. The resulting audio signal is sampled via an audio sampling module 214 to generate a set of audio samples for further processing. The audio source 212 includes and/or is associated with an analog to digital converter (ADC) or other means can be utilized to convert raw analog audio information into a digital format for further processing. While the audio source 212 and audio sampling module 214 are illustrated in system 210 as distinct units, these components could be implemented as a single unit. For instance, the audio source 212 can be directed by a controller or processing unit to generate audio signal data only at intermittent designated times corresponding to a desired sample rate. Other techniques for generating and sampling an audio signal are also possible, as described in further detail below.

Given a set of audio samples from the audio sampling module 214, an audio spectrogram module 216 generates a spectrogram of the samples over windows of T second duration, for a predefined window length T. The windows may be overlapping or non-overlapping. Subsequently, a classifier module 218 determines whether the audio samples include information indicative of speech by classifying the spectrogram. For example, based on these windows, a classifier module 218 computes classifier decisions indicative of whether speech is present in each of the windows using a Support Vector Machine (SVM), Gaussian mixture model, or other classifier(s).

The system 210 illustrated by FIG. 2 can be associated with a single device or multiple devices. For instance, each of the components 212, 214, 216, 218 can be implemented by a single mobile device 100. Alternatively, the audio source 212 and audio sampling module 214 can be implemented by a mobile device 100, and the mobile device 100 can be configured to provide collected audio samples to an external entity, such as a network- or cloud-based computing service, which in turn implements the audio spectrogram module 216 and classifier module 218 and returns the corresponding classifier decisions to the mobile device. Other implementations are also possible.

Additionally, the audio sampling module 214, audio spectrogram module 216 and classifier module 218 can be implemented in software, hardware or a combination of software and hardware. Here, the modules 214, 216, 218 are implemented in software via the general purpose processor 111, which executes software stored on the memory 140 and comprising processor-executable instructions that, when executed by the general purpose processor 111, cause the general purpose processor 111 to implement the functionality of the modules 212, 214, 216. Other implementations are also possible.

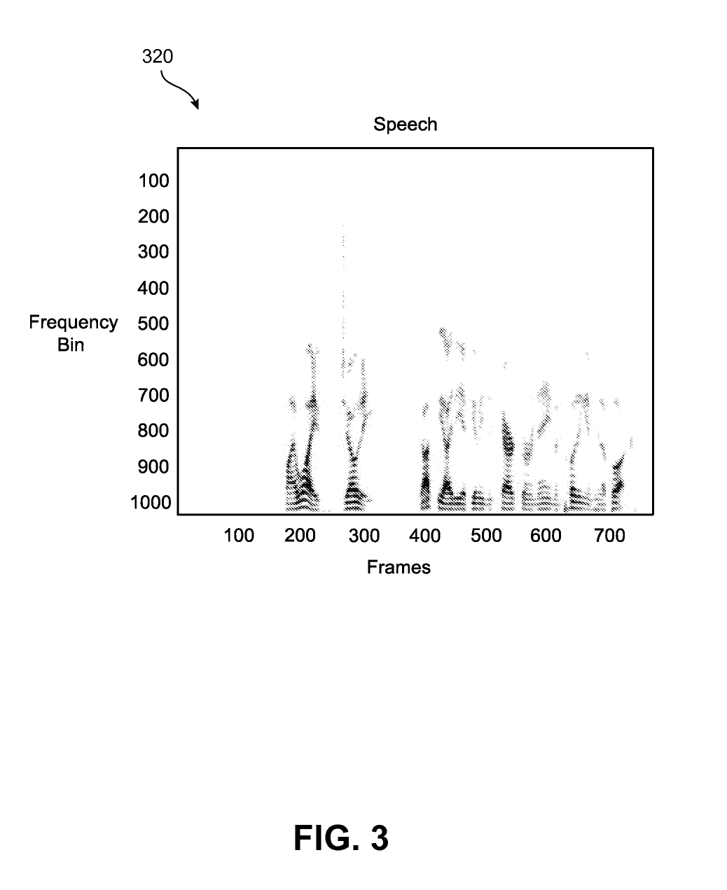

A spectrogram is a representation of the energy in different frequency bands of a time-varying signal. It is typically displayed as a two-dimensional image of energy intensity with time on the x-axis and frequency on the y-axis. Thus, a pixel at a given location (t, f) of the spectrogram represents the energy of the signal at time t and at frequency f. An example of a spectrogram for an audio signal containing only speech is given by diagram 320 in FIG. 3. In the diagram 320, each frame consists of 8 ms of audio data and each frequency bin corresponds to a spectral range of 7.8125 Hz. The bottom bin of the spectrogram (bin 1023) corresponds to the frequency range 0.0000-7.8125 Hz, and the top bin corresponds to the frequency range 7992.1875-8000.0000 Hz.

The classifier module 218 is trained using training signals that include positive examples of audio signals containing speech and negative examples of audio signals containing ambient environment sounds, but no speech. The ambient environment sounds may contain examples of music, both with and without vocals. These training signals are, in turn, utilized to detect speech in an incoming audio signal.

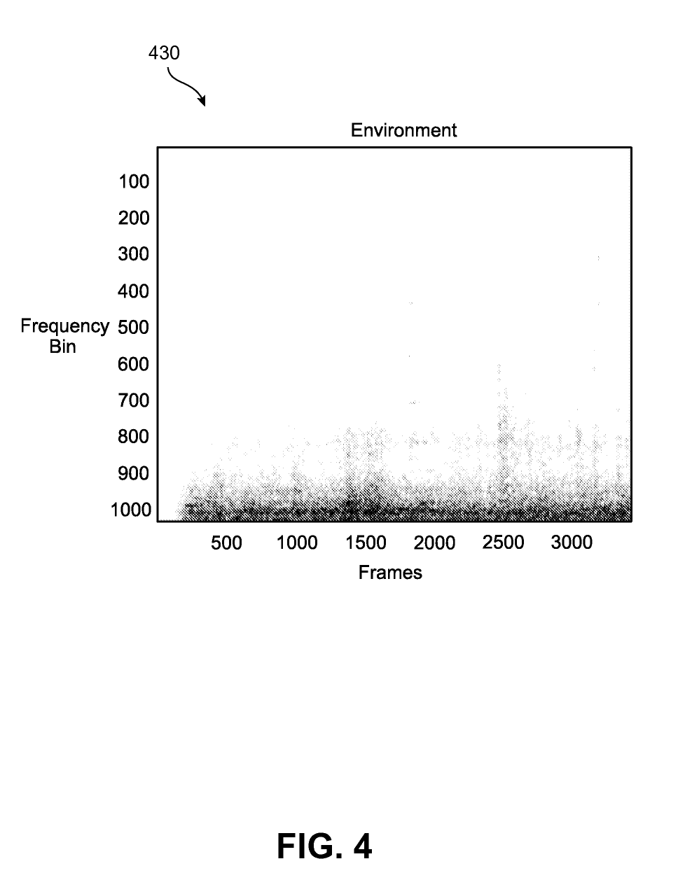

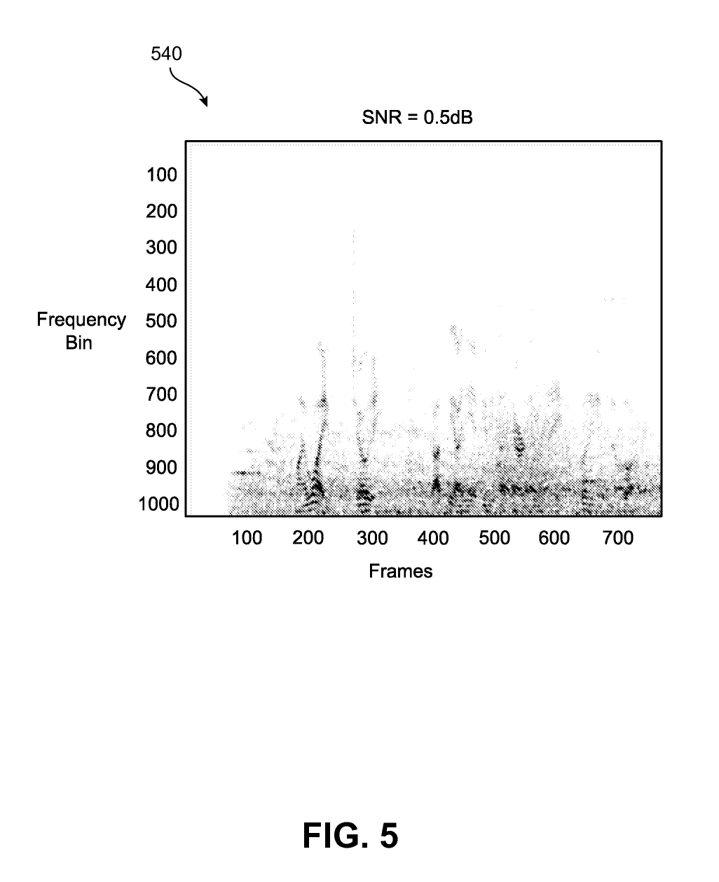

As shown by diagrams 320, 430, 540, 650 in FIGS. 3-6, the presence of speech presents itself in identifiable ways in spectrograms such that the presence of speech can be determined via visual inspection of a corresponding spectrogram by looking for wavy bands in the 0-3 kHz frequency range. These bands are present in the diagram 320 illustrating a spectrogram containing only speech, as shown in FIG. 3. Ambient environment sounds have no such bands, as shown in the diagram 430 in FIG. 4 of a spectrogram containing only ambient environment sounds. When speech is present with ambient environment sounds in the background, the wavy bands associated with speech are still visually identifiable, even down to very low SNRs. This is illustrated by diagram 540 in FIG. 5, which shows a spectrogram containing speech and ambient environment sounds combined at a speech SNR of 0.5 dB.

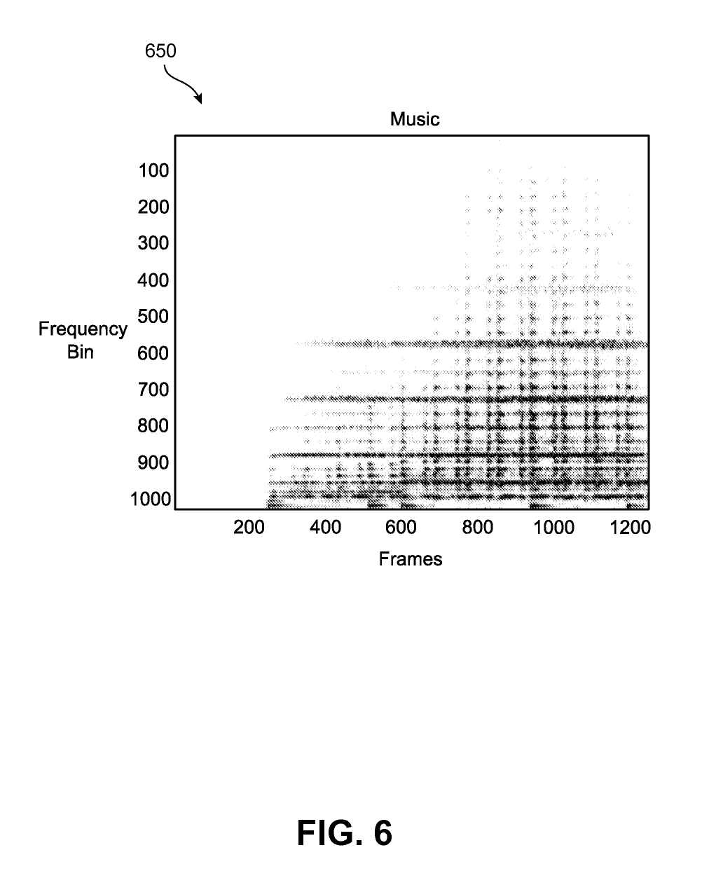

As shown by a comparison of the diagrams 320 and 540 in FIGS. 3 and 5 to a diagram 650 in FIG. 6, the spectrogram of an audio signal containing music, as shown in FIG. 6, appears different from a spectrogram containing speech. In particular, the wavy bands in the speech spectrogram of diagram 320 are straight in the music spectrogram of diagram 650. The differences between diagrams 320 and 650 exist because instruments typically play notes from a discrete (as opposed to continuous) scale. When vocals are present in the music, wavy bands similar to those shown in diagram 320 are superimposed on top of the straight bands shown in diagram 650. However, a distinction between vocals versus speech can be made by visually identifying the presence of straight bands representing music accompanying the wavy bands.

In view of the characteristics shown in the spectrograms in FIGS. 3-6, classification of audio to determine the presence of speech in the audio can be handled by the classifier module 218 as a visual identification problem. To this end, the classifier module 218 utilizes similar techniques for solving other visual identification problems, such as handwriting recognition, to classify spectral data provided by the audio spectrogram module 216. The classifier module 16 can use, e.g., a SVM and/or any other classification technique that is effective at solving visual identification problems.

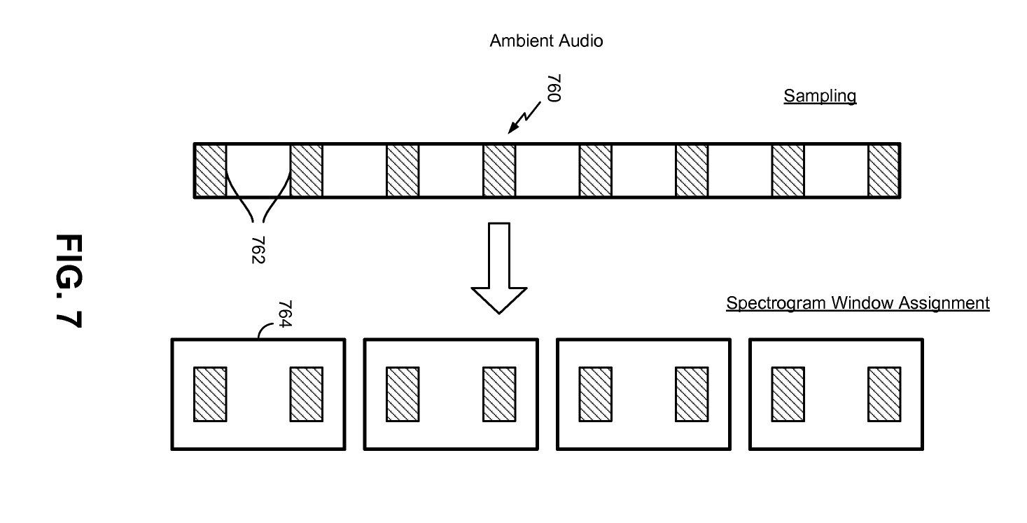

FIG. 7 illustrates an example of a technique for obtaining samples 762 from an ambient audio stream 760 and grouping the audio samples 762 into windows 764 for spectrogram processing. An ambient audio stream 760 may be sampled continuously to generate a continuous set of audio samples 762, which can be subsequently grouped into spectrogram windows 764 for further processing. However, in some cases, such contiguous segments of audio may not be available for analysis. For instance, due to privacy concerns or other reasons, a mobile device user may desire only to consent to sparse, intermittent sampling of the ambient audio environment. Further, continuous recording of the ambient audio stream 760 may not be efficient in terms of power usage or battery life. Thus, as shown in FIG. 7, processing of an ambient audio stream 760 can proceed as described herein based on a sparse and intermittent subsampling of the ambient audio stream 760.

To enhance device user privacy with respect to the usage of audio information recorded at the device, various measures can be employed to render unauthorized use of the recorded audio information impracticable or impossible. For instance, as noted above, recording and/or sampling of the ambient audio stream 760 can be performed according to a low duty cycle (e.g., 50 ms of sampling every 500 ms) such that the underlying audio cannot be reconstructed from the collected samples. Additionally or alternatively, collected audio samples can be randomly shuffled and/or otherwise rearranged such that reconstruction of the original audio stream would be difficult or impossible. As the techniques described herein operate only to determine the presence of speech from spectral data associated with collected audio samples, rather than performing speech recognition to identify any particular speech, the performance of the techniques described herein are not significantly impacted by the inability to reconstruct the original audio stream. As another safeguard to user privacy, audio data can be processed such that it never leaves the device at which it is recorded. For instance, a device can be configured to sample and buffer ambient audio, compute the spectrogram for the buffered samples, and then discard the underlying audio data. In any case, the sampling and/or processing procedures used with respect to audio samples 762 from an ambient audio stream 760 can be conveyed to a device user in order to enable the user to review and consent to the procedures prior to their use.

The number and/or size of spectrogram windows 764 utilized for classification of collected audio samples 762 are chosen according to various factors, such as latency requirements of application(s) utilizing the classification (e.g., applications with more lenient latency requirements can utilize larger amounts of data and/or larger spectrogram windows), available computing resources, or the like.

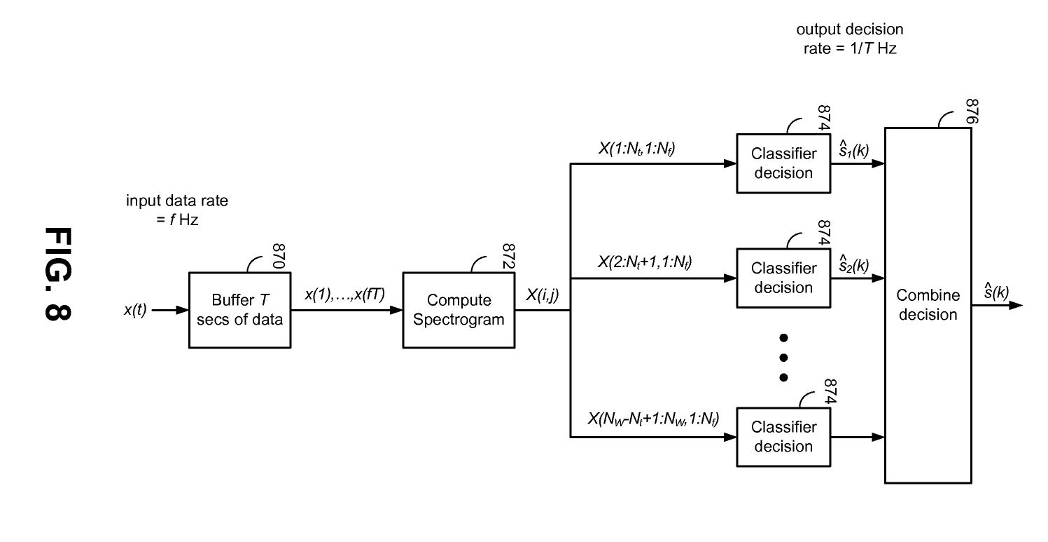

FIG. 8 and the following description provide an example technique by which a spectrogram classification approach can be implemented for speech detection. Other architectures and techniques are also possible. As used herein, the input audio data stream is denoted as x(t), where t=1, 2, . . . is a sample index. The input data rate is f Hz. As shown at block 870, T seconds of data are buffered to obtain audio samples x(1), . . . , x(fT). Any suitable values of f and T can be utilized, e.g., f=8 kHz and T=5 sec. In any case, the time T utilized for buffering data associated with the spectrogram can be greater than the buffering time associated with conventional VAD techniques. During this T second period, it is assumed that speech is either present or not present, i.e., s=1 or s=0 for a binary state parameter s.

At block 872, the spectrogram is computed from the buffered data. The spectrogram can be computed using any suitable technique, such as a technique based on the short-time Fourier transform (STFT) of respective portions of the buffered data and/or other suitable techniques. For instance, the spectrogram can be computed via the following formula:

$$X ( i , j ) = {\vert {\sum }_{t = 1}^{N} x ( t + {N}_{m} ( i - 1 ) ) w ( t ) {e}^{j2π ( t - 1 ) ( j - 1 ) / N} \vert}^{2} .$$

In the above formula, w(t) for t=1, . . . , N represents a window function. The window function can be, e.g., a Hamming window, which can be constructed as follows:

$$w ( t ) = 0.54 - 0.46 cos ( \frac{2 π ( t - 1 )}{N - 1} ) .$$

The window function is used to reduce leakage between different frequency bins in the spectrogram. The indices (i,j) represent the discrete (time, frequency) index of the spectrogram for i=1, . . . , N_{w} and j=1, . . . ,└N/2┘, where

$${N}_{w} = ⌊ \frac{fT - N}{{N}_{m}} + 1 ⌋ .$$

Thus, the spectrogram consists of the power spectral densities of overlapping temporal segments of the audio signal, evaluated in the frequency range [1, f/2] Hz. The parameter N represents the number of audio samples used in each power spectral density estimate. An example value for N is 256, although other values could be used. The parameter Nₘ represents the temporal increment (in samples) per spectrogram column. In an example where Nₘ is assigned a value of 64, an overlap (e.g., equal to 1−Nₘ/N) of 75% is produced.

As FIG. 8 further illustrates, once the T-second spectrogram is computed, it is broken into frames or windows of width Nₜ and height N_{f}, both expressed in terms of number of samples. While FIG. 8 illustrates that the spectrogram is divided into temporally non-overlapping frames, overlapping frames could also be used. In the example shown in FIG. 8, frames can be generated according to the following:

Xₙ=X(n:Nₜ+n−1,1:N_{f}),

for n=1, . . . , N_{W}−Nₜ+1 where N_{W} represents the total width of the spectrogram. Stated another way, Xₙ represents a frame of the spectrogram of width Nₜ and height N_{f}. Example values are Nₜ=30 and N_{f}=64, although other values are possible.

As shown at blocks 874 of FIG. 8, each frame Xn of the generated spectrogram is provided as input to a classifier, which computes a decision ŝₙ. An overall decision ŝₙ ∈ {0,1} is computed as a function of the individual SVM decisions, i.e., ŝ₁, . . . , ŝ_{N}_{_{W}}_{-N}_{ₜ}₊₁ ∈ {0,1}.

As discussed in further detail below, the classifier is trained to detect voiced speech. When speech is present in the audio signal, approximately half of the frames Xₙ will contain voiced speech. Thus, the overall decision ŝₙ of the classifier is computed at block 876 based on the fraction of individual decisions for which speech is detected. This can be expressed as follows:

$$\hat{s} = \{ \begin{matrix}1 & if \frac{1}{{N}_{W} - {N}_{t} + 1} {\sum }_{n = 1}^{{N}_{W} - {N}_{t} + 1} {\hat{s}}_{n} > τ \\ 0 & otherwise .\end{matrix}$$

The parameter τ is a threshold that is chosen based on a desired receiver operating point (ROC). The ROC is based on at least one of desired detection probability or false alarm probability. For instance, the ROC can define a (detection, false alarm) probability pair.

As an alternative to the above classification technique, each classifier decision block 874 can output a margin associated with the decision, indicating how far from the decision boundary the feature vector lies. These decisions can then be soft combined at block 876 to generate an overall detection decision. One such example of this is as follows:

$$\hat{s} = \{ \begin{matrix}1 & if \frac{1}{{N}_{W} - {N}_{t} + 1} {\sum }_{n = 1}^{{N}_{W} - {N}_{t} + 1} f ( {g}_{n} ) > τ \\ 0 & otherwise ,\end{matrix}$$

where gₙ represents the margin provided as output by the n-th classifier block 874, and f is a function that maps the margin appropriately.

In the classification procedure shown by FIG. 8 described above, the classifier blocks 874 are implemented using a SVM. However, other forms of classifiers can be used in place of, or in addition to, the SVM, such as a neural network classifier, a classifier based on a Gaussian mixture model or hidden Markov model, etc. Additionally or alternatively, a more general detector can be built by bootstrapping the spectrogram and classifier(s) to a less complex detector, such as one based on zero-crossing rate statistics (ZCR). For instance, a ZCR-based detector can be configured to operate with a high detection rate but a high false alarm rate. When speech is detected by the ZCR, the spectrogram/classifier method described above, which is configured to operate with a high detection rate and a low false alarm rate, is triggered.

Prior to speech detection, the classifier is trained using positive examples of speech and negative examples of both various ambient environment noise and music with and without vocals. Alternatively, the classifier can be trained using positive examples of speech combined with various types of environmental noise at a range of SNRs (e.g., −3 dB to +30 dB) and negative examples of just environmental noise. The input to the classifier is a spectrogram frame of width Nₜ and height N_{f}. Based on the training of the classifier, the classifier renders its decision(s) in a manner similar to a visual pattern recognition problem by determining the statistical proximity of features in the given spectrogram frame to a reference speech model obtained via the training.

The speech detection described above can be implemented at a mobile device and/or by one or more applications running on a mobile device to provide user context information. This user context information can in turn be utilized to enhance a user's experience with respect to the mobile device. For instance, identifying segments of an audio signal that contain dialogue can be implemented as a component of a speaker recognition system. On-device speaker recognition systems enhance contextual awareness by identifying the type of environment the user is in, who the user is in the vicinity of, when the user is speaking, the fraction of time the user spends interacting with certain work colleagues or friends, etc. Further, identifying dialogue in the vicinity of a mobile device can in its own right provide contextual information. This context information can be used as a central element of various applications, such as automatic note takers, voice recognition platforms, and so on.

This context information can also be utilized as the basis of contextual reminders. For instance, a task can be configured at a mobile device and associated with a particular person. When the device detects that the person associated with the task is speaking in the vicinity of the device, an alert for the task can be issued. The identity of a person speaking in the area of the device can be obtained by the speech classifier itself, or it alternatively can be based at least partially on other information available to the device, such as contact lists, calendars, or the like. As another example, the presence or absence of speech in the area of a given device can be utilized to estimate the availability and/or interruptibility of a user. For instance, if a device detects speech in its surrounding area, the device can infer that the availability of the user is limited at that time. Additionally, if the device determines from other available information (e.g., calendars, positioning systems, etc.) that a user is at work and speech in the surrounding area is detected, the device can infer that the user is in a meeting and should not be interrupted. In this case, the device can be configured to automatically route incoming calls to voice mail and/or perform other suitable actions.

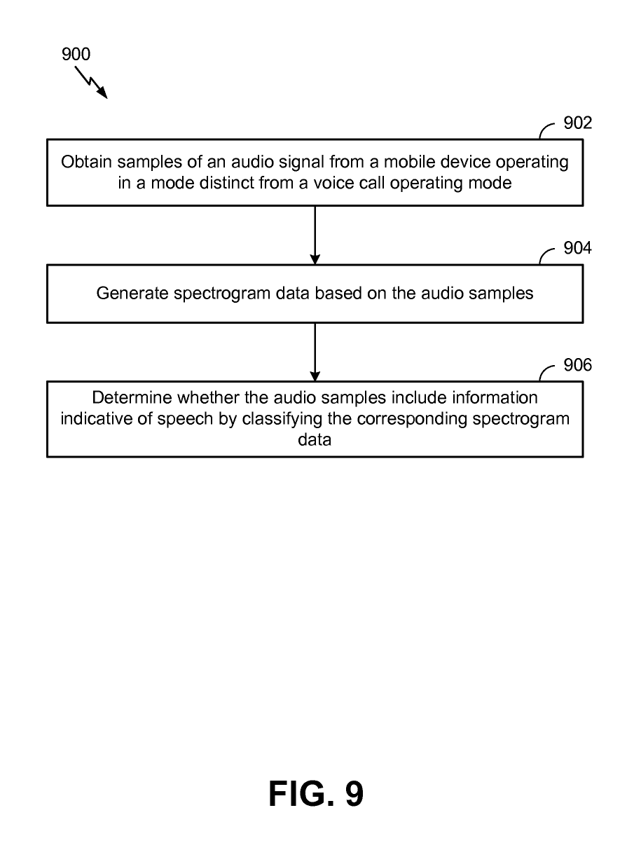

Referring to FIG. 9, with further reference to FIGS. 1-8, a process 900 of identifying presence of speech associated with a device 100 includes the stages shown. The process 900 is, however, an example only and not limiting. The process 900 can be altered, e.g., by having stages added, removed, rearranged, combined, and/or performed concurrently. Still other alterations to the process 900 as shown and described are possible. At stage 902, samples of an audio signal are obtained from a mobile device 100 operating in a mode distinct from a voice call operating mode. The audio samples can be obtained using an audio source 212, such as a microphone 135 or the like, an audio sampling module 214, and/or other suitable components. The samples may be intermittent and noncontiguous samples of ambient audio associated with the mobile device. Alternatively, sampling at stage 902 may be continuous, or conducted in any other suitable manner.

At stage 904, spectrogram data is generated, e.g., by an audio spectrogram module 216 or the like, based on the audio samples obtained at stage 902. At stage 906, a determination is made regarding whether the audio samples include information indicative of speech by classifying the spectrogram data generated at stage 904. This classification is done using, e.g., a classifier module 218, which may operate according to the architecture shown in FIG. 8 and/or in any other suitable manner. The audio sampling module 214, audio spectrogram module 216, and/or classifier module 218 can be implemented to perform the actions of process 900 in any suitable manner, such as in hardware, software (e.g., as processor-executable instructions stored on a non-transitory computer readable medium and executed by a processor) or a combination of hardware and/or software.

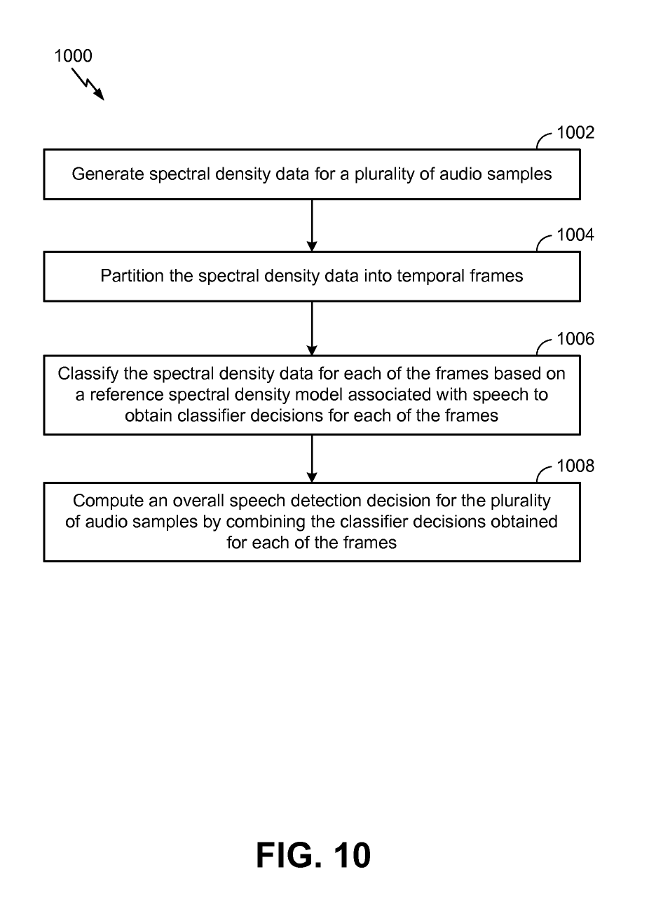

Referring to FIG. 10, with further reference to FIGS. 1-8, a process 1000 of processing and classifying samples obtained from an audio signal includes the stages shown. The process 1000 is, however, an example only and not limiting. The process 1000 can be altered, e.g., by having stages added, removed, rearranged, combined, and/or performed concurrently. Still other alterations to the process 1000 as shown and described are possible. At stage 1002, spectral density data (e.g., a spectrogram) is generated for a plurality of audio samples. At stage 1004, these data are partitioned into temporal frames or time windows. These frames may be overlapping or non-overlapping.

At stage 1006, the spectral density data are classified for each of the frames based on a reference spectral density model associated with speech to obtain classifier decisions for each of the frames. These classifier decisions can be discrete values (“hard decisions”) corresponding to whether or not the frames contain information indicative of speech, or alternatively the decisions can be soft decisions corresponding to a calculated probability that the frames contain information indicative of speech.

At stage 1008, an overall speech detection decision is computed for the plurality of audio samples by combining the classifier decisions obtained for each of the frames at stage 1006. As described above with reference to FIG. 8, individual classifier decisions can be combined based on the fraction of individual decisions for which speech is detected. This combination can result in a hard classifier decision for the plurality of audio samples by, e.g., comparing the fraction of individual decisions for which speech is detected to a threshold. A threshold used in this manner can be based on various factors, such as a desired detection probability, a desired false alarm probability, etc.

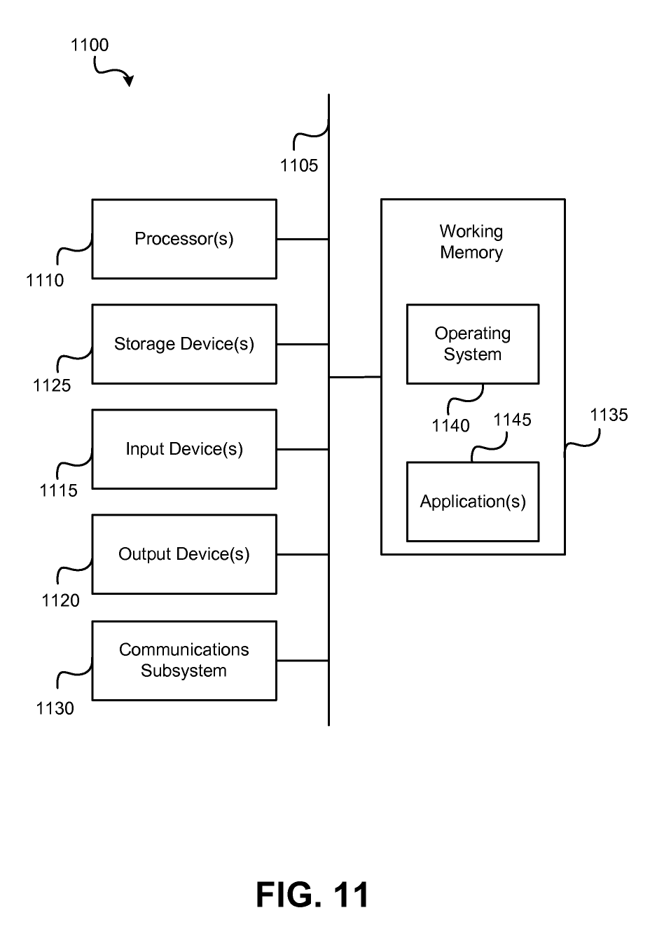

A computer system as illustrated in FIG. 11 may be utilized to at least partially implement the functionality of the previously described computerized devices. FIG. 11 provides a schematic illustration of one embodiment of a computer system 1100 that can perform the methods provided by various other embodiments, as described herein, and/or can function as a mobile device or other computer system. It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner.

The computer system 1100 is shown comprising hardware elements that can be electrically coupled via a bus 1105 (or may otherwise be in communication, as appropriate). The hardware elements may include one or more processors 1110, including without limitation one or more general-purpose processors and/or one or more special-purpose processors (such as digital signal processing chips, graphics acceleration processors, and/or the like); one or more input devices 1115, which can include without limitation a mouse, a keyboard and/or the like; and one or more output devices 1120, which can include without limitation a display device, a printer and/or the like. The processor(s) 1110 can include, for example, intelligent hardware devices, e.g., a central processing unit (CPU) such as those made by Intel® Corporation or AMD®, a microcontroller, an ASIC, etc. Other processor types could also be utilized.

The computer system 1100 may further include (and/or be in communication with) one or more non-transitory storage devices 1125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1100 might also include a communications subsystem 1130, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 1130 may permit data to be exchanged with a network (such as the network described below, to name one example), other computer systems, and/or any other devices described herein. In many embodiments, the computer system 1100 will further comprise a working memory 1135, which can include a RAM or ROM device, as described above.

The computer system 1100 also can comprise software elements, shown as being currently located within the working memory 1135, including an operating system 1140, device drivers, executable libraries, and/or other code, such as one or more application programs 1145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer), and such code and/or instructions can be used to configure and/or adapt a general purpose computer (or other device) to perform one or more operations in accordance with the described methods.

A set of these instructions and/or code might be stored on a computer-readable storage medium, such as the storage device(s) 1125 described above. In some cases, the storage medium might be incorporated within a computer system, such as the system 1100. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.) then takes the form of executable code.

Substantial variations may be made in accordance with specific desires. For example, customized hardware might also be used, and/or particular elements might be implemented in hardware, software (including portable software, such as applets, etc.), or both. Further, connection to other computing devices such as network input/output devices may be employed.

A computer system (such as the computer system 1100) may be used to perform methods in accordance with the disclosure. Some or all of the procedures of such methods may be performed by the computer system 1100 in response to processor 1110 executing one or more sequences of one or more instructions (which might be incorporated into the operating system 1140 and/or other code, such as an application program 1145) contained in the working memory 1135. Such instructions may be read into the working memory 1135 from another computer-readable medium, such as one or more of the storage device(s) 1125. Merely by way of example, execution of the sequences of instructions contained in the working memory 1135 might cause the processor(s) 1110 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1100, various computer-readable media might be involved in providing instructions/code to processor(s) 1110 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1125. Volatile media include, without limitation, dynamic memory, such as the working memory 1135. Transmission media include, without limitation, coaxial cables, copper wire and fiber optics, including the wires that comprise the bus 1105, as well as the various components of the communication subsystem 1130 (and/or the media by which the communications subsystem 1130 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, a Blu-Ray disc, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1100. These signals, which might be in the form of electromagnetic signals, acoustic signals, optical signals and/or the like, are all examples of carrier waves on which instructions can be encoded, in accordance with various embodiments of the invention.

The communications subsystem 1130 (and/or components thereof) generally will receive the signals, and the bus 1105 then might carry the signals (and/or the data, instructions, etc. carried by the signals) to the working memory 1135, from which the processor(s) 1105 retrieves and executes the instructions. The instructions received by the working memory 1135 may optionally be stored on a storage device 1125 either before or after execution by the processor(s) 1110.

The methods, systems, and devices discussed above are examples. Various alternative configurations may omit, substitute, or add various procedures or components as appropriate. For instance, in alternative methods, stages may be performed in orders different from the discussion above, and various stages may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for identifying presence of speech associated with a mobile device, the method comprising:
obtaining a plurality of audio samples from the mobile device while the mobile device operates in a mode distinct from a voice call operating mode;
generating spectrogram data from the plurality of audio samples; and
determining whether the plurality of audio samples include information indicative of speech by classifying the spectrogram data.

2. The method of claim 1 wherein the obtaining comprises obtaining noncontiguous samples of ambient audio at an area near the mobile device.

3. The method of claim 1 wherein the determining comprises classifying the spectrogram data using at least one support vector machine (SVM).

4. The method of claim 1 wherein the classifying comprises:
partitioning the spectrogram data into temporal frames;
obtaining individual decisions for each of the frames indicative of whether speech is detected in respective ones of the frames; and
combining the individual decisions to obtain an overall decision relating to whether the plurality of audio samples include information indicative of speech.

5. The method of claim 4 wherein the combining comprises combining the individual decisions based on a number of individual decisions for which speech is detected relative to a total number of the individual decisions.

6. The method of claim 5 wherein the combining further comprises comparing the number of individual decisions for which speech is detected to a threshold that is based on at least one of a desired detection probability or a desired false alarm probability.

7. The method of claim 4 wherein the partitioning comprises partitioning the spectrogram data into non-overlapping temporal frames.

8. The method of claim 4 wherein the obtaining the individual decisions comprises computing a statistical proximity of features of the spectrogram data for each of the frames to features of a reference speech model.

9. The method of claim 8 further comprising generating the reference speech model using a training procedure.

10. The method of claim 1 further comprising randomizing an order of the plurality of audio samples prior to generating the spectrogram data.

11. A speech detection system comprising:
an audio sampling module configured to obtain a plurality of audio samples associated with an area at which a device is located while the device operates in a mode distinct from a voice call operating mode;
an audio spectrogram module communicatively coupled to the audio sampling module and configured to generate spectrogram data from the plurality of audio samples; and
a classifier module communicatively coupled to the audio spectrogram module and configured to determine whether the plurality of audio samples include information indicative of speech by classifying the spectrogram data.

12. The system of claim 11 wherein the audio sampling module is further configured to obtain the plurality of audio samples by obtaining noncontiguous samples of ambient audio associated with the area at which the device is located.

13. The system of claim 11 wherein the classifier module is further configured to classify the spectrogram data using at least one support vector machine (SVM).

14. The system of claim 11 wherein:
the audio spectrogram module is further configured to partition the spectrogram data into temporal frames; and
the classifier module is further configured to classify the spectrogram data by obtaining individual decisions for each of the frames indicative of whether speech is detected in respective ones of the frames and combining the individual decisions to obtain an overall decision relating to whether the plurality of audio samples include information indicative of speech.

15. The system of claim 14 wherein the classifier module is further configured to combine the individual decisions by comparing a number of individual decisions for which speech is detected to a threshold, and wherein the threshold is based on at least one of a desired detection probability or a desired false alarm probability.

16. The system of claim 14 wherein the audio spectrogram module is further configured to partition the spectrogram data into non-overlapping temporal frames.

17. The system of claim 14 wherein the classifier module is further configured to classify the spectrogram data by computing a statistical proximity of features of the spectrogram data for each of the frames to features of a reference speech model.

18. The system of claim 17 wherein the classifier module is further configured to generate the reference speech model using a training procedure.

19. The system of claim 11 wherein the audio sampling module is further configured to randomize an order of the plurality of audio samples prior to processing of the audio samples by the audio spectrogram module.

20. The system of claim 11 further comprising a microphone communicatively coupled to the audio sampling module and configured to produce an audio signal based on ambient audio associated with the area at which the device is located, wherein the audio sampling module is configured to obtain the audio samples from the audio signal.

21. The system of claim 11 wherein the device is a mobile wireless communication device.

22. A system for detecting presence of speech in an area associated with a mobile device, the system comprising:
sampling means for obtaining a plurality of audio samples from the area associated with the mobile device while the mobile device operates in a mode distinct from a voice call operating mode;
spectrogram means, communicatively coupled to the sampling means, for generating a spectrogram comprising spectral density data corresponding to the plurality of audio samples; and
classifier means, communicatively coupled to the spectrogram means, for determining whether the plurality of audio samples include information indicative of speech by classifying the spectral density data of the spectrogram.

23. The system of claim 22 wherein the sampling means comprises means for obtaining noncontiguous samples of ambient audio from the area associated with the mobile device.

24. The system of claim 22 wherein the classifier means comprises means for classifying the spectral density data of the spectrogram using at least one support vector machine (SVM).

25. The system of claim 22 wherein:
the spectrogram means comprises means for partitioning the spectrogram into temporal frames; and
the classifier means comprises means for obtaining individual decisions for each of the frames of the spectrogram indicative of whether speech is detected in respective ones of the frames and means for combining the individual decisions to obtain an overall decision relating to whether the plurality of audio samples include information indicative of speech.

26. The system of claim 25 wherein the classifier means further comprises means for combining the individual decisions by comparing a number of individual decisions for which speech is detected to a threshold, and wherein the threshold is based on at least one of a desired detection probability or a desired false alarm probability.

27. The system of claim 25 wherein the spectrogram means further comprises means for partitioning the spectrogram into non-overlapping temporal frames.

28. The system of claim 25 wherein the classifier means further comprises means for classifying the spectrogram by computing a statistical proximity of features of the spectrogram for each of the frames to features of a reference speech model.

29. The system of claim 28 wherein the classifier means further comprises means for generating the reference speech model using a training procedure.

30. The system of claim 22 wherein the sampling means comprises means for randomizing an order of the plurality of audio samples prior to processing of the audio samples by the spectrogram means.

31. A computer program product residing on a processor-executable computer storage medium, the computer program product comprising processor-executable instructions configured to cause a processor to:
obtain a plurality of audio samples from an area associated with a mobile device while the mobile device operates in a mode distinct from a voice call operating mode;
generate a spectrogram comprising spectral density data corresponding to the plurality of audio samples; and
determine whether the plurality of audio samples include information indicative of speech by classifying the spectral density data of the spectrogram.

32. The computer program product of claim 31 wherein the instructions configured to cause the processor to obtain the plurality of audio samples are further configured to cause the processor to obtain noncontiguous samples of ambient audio from the area associated with the mobile device.

33. The computer program product of claim 31 wherein the instructions configured to cause the processor to determine are further configured to cause the processor to classify the spectral density data of the spectrogram using at least one support vector machine (SVM).

34. The computer program product of claim 31 wherein:
the instructions configured to cause the processor to generate the spectrogram are further configured to cause the processor to partition the spectrogram into temporal frames; and
the instructions configured to cause the processor to determine are further configured to cause the processor to obtain individual decisions for each of the frames of the spectrogram indicative of whether speech is detected in respective ones of the frames and to combine the individual decisions to obtain an overall decision relating to whether the plurality of audio samples include information indicative of speech.

35. The computer program product of claim 34 wherein the instructions configured to cause the processor to determine are further configured to cause the processor to combine the individual decisions by comparing a number of individual decisions for which speech is detected to a threshold, and wherein the threshold is based on at least one of a desired detection probability or a desired false alarm probability.

36. The computer program product of claim 34 wherein the instructions configured to cause the processor to generate the spectrogram are further configured to partition the spectrogram into non-overlapping temporal frames.

37. The computer program product of claim 34 wherein the instructions configured to cause the processor to determine are further configured to cause the processor to classify the spectrogram by computing a statistical proximity of features of the spectrogram for each of the frames to features of a reference speech model.

38. The computer program product of claim 37 wherein the instructions configured to cause the processor to determine are further configured to cause the processor to generate the reference speech model using a training procedure.

39. The computer program product of claim 31 wherein the instructions configured to cause the processor to obtain the plurality of audio samples are further configured to cause the processor to randomize an order of the plurality of audio samples prior to generation of the spectrogram.
